(19) United States
(12) Patent Application Publication
(10) Pub. No.: US 2026/0265096 A1
(43) Pub. Date: Sep. 10, 2026

(54) METHODOLOGY TO REMOVE SOLUBLE HYDROCARBONS FROM CONTAMINATED WASTEWATER IN A WASTEWATER POND

(71) Applicant: SAUDI ARABIAN OIL COMPANY, Dhahran (SA)

(72) Inventors: Hussain F. Alhabib, Safwa (SA); Salman F. Aldossari, Alkhobar (SA); Abdulaziz I. Alsalem, Dammam (SA)

(73) Assignee: SAUDI ARABIAN OIL COMPANY, Dhahran (SA)

(21) Appl. No.: 19/070,650

(22) Filed: Mar. 5, 2025

(51) Int. Cl. C02F 3/02; C02F 3/34; C02F 101/34

(52) U.S. Cl. CPC C02F 3/02; C02F 3/34; C02F 2101/34; C02F 2209/00; C02F 2209/40; C02F 2305/06

(57) ABSTRACT

Systems and inventions for removing contaminants from wastewater are disclosed. The system may include a wastewater pond and a conditioning system. The wastewater pond includes a waterproof liner, configured to retain wastewater in the wastewater pond, a divider configured to partition the wastewater pond into at least a first section and a second section, where the divider adjustably controls fluid communication between the first section and the second section, and a biological agent disposed within the first section configured to decontaminate wastewater. The conditioning system is configured to maintain conditions in the first section favorable to decontamination by the biological agent

### BACKGROUND

Oil and gas processing facilities tend to produce oily wastewater on a continuous basis. Oily wastewater may be discharged to a wastewater pond for temporary storage where the oily wastewater can evaporate while stored. A third-party wastewater service can remove any remaining wastewater.

Oily wastewater may contain contaminants that can pollute the environment. Pollution may occur during evaporation or if the pond leaks. Wastewater ponds are typically lined with a high-density polyethylene (HDPE) liner, though contaminants may leak if the liner fails. To reduce risk of environmental pollution, there is an interest in removing contaminants before water is stored in a wastewater pond.

Non-soluble contaminants are easily separated from the wastewater using conventional mechanical and chemical means due to the density difference between the two immiscible phases that allows separation to occur. However, soluble contaminants, such as ethylene glycol (HO—CH₂CH₂—OH), are not susceptible to the same separation technology.

Typically, during emergencies, oily wastewater is discharged to an evaporation pond without prior treatment. Then, the oily wastewater is hauled to a third-party wastewater treatment plant. During this period, wastewater that might be saturated with ethylene glycol imposes a risk to the surrounding environment. For example, air emissions and soil and groundwater contamination because of failure of the pond's liners.

Accordingly, there exists a need for processes and systems to reduce contamination from soluble organic compounds in evaporation ponds without prior treatment.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system, the system may include a wastewater pond and a conditioning system. The wastewater pond includes a waterproof liner, configured to retain wastewater in the wastewater pond, a divider configured to partition the wastewater pond into at least a first section and a second section, where the divider adjustably controls fluid communication between the first section and the second section, and a biological agent disposed within the first section configured to decontaminate wastewater. The conditioning system is configured to maintain conditions in the first section favorable to decontamination by the biological agent.

In one aspect, embodiments disclosed herein relate to a process for removing contaminants from contaminated wastewater, the process including receiving contaminated wastewater into a first section of a wastewater storage pond, wherein the wastewater storage pond is divided into at least a first section and a second section by a divider disposed between the first section and the second section, and conditioning the contaminated wastewater in the first section of the wastewater pond to maintain conditions in the first section of the wastewater pond favorable to decontamination by a biological agent. The process further including producing, using the biological agent, decontaminated wastewater from the contaminated wastewater in the first section, and transferring, upon satisfying a decontamination condition, decontaminated wastewater from the first section to the second section.

Other aspects and advantages of the claimed subject matter will be apparent from the following description and the appended claims.

### BRIEF DESCRIPTION OF THE DRAWINGS

The embodiments herein may be better understood by referring to the following description in conjunction with the accompanying drawings in which like reference numerals indicate analogous, identical, or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a diagram of a conventional wastewater pond from prior art.

FIG. 2 is a diagram of a wastewater pond according to one or more embodiments disclosed herein.

FIG. 3 is a diagram of a wastewater pond according to one or more embodiments disclosed herein.

FIG. 4 is block diagram showing the steps of one or more embodiments disclosed herein.

FIG. 5 is block diagram showing the steps of one or more embodiments disclosed herein.

FIG. 6 is a block diagram showing the steps of one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a wastewater pond may reference two or more such wastewater ponds.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

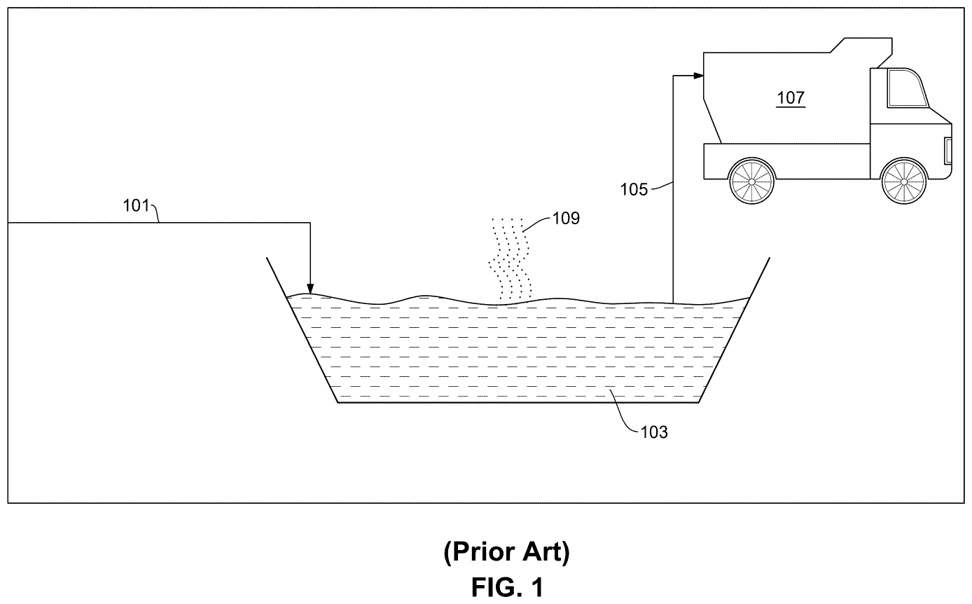

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Large industrial ponds can store large amounts of wastewater even if that wastewater is suddenly discharged under emergency conditions. Later a third-party wastewater treatment provider can retrieve the wastewater for proper disposal. However, leaks and evaporation may allow contamination from a pond to escape into the environment. The severity of such leaks can be reduced by reducing the concentration of contaminants in the wastewater. Biological agents such as those hosted in bacterial beds can be used to break down contaminants. As a non-limiting example, contaminants such as ethylene glycol (HO—CH₂CH₂—OH) can be broken down by aerobic digestion in bacteria.

Bacterial beds are structures that contain bacteria. Bacterial beds include the media for moving bed biofilm reactors (MBBR). For example, without limitation, media for a moving bed biofilm reactor may have coin-shaped carriers composed of high-density polyethylene (HDPE) designed for both maximum surface area and channels for movement of external fluid. Such coin-shaped carriers allow wastewater to flow through while contacting bacteria hosted on a carrier's surface. Carriers may be free-floating, floating with an anchoring system, or rigidly fixed in place.

A pond may be partitioned into two or more sections where at least one section contains biological agents. Sections with aerobic bacteria should maintain conditions appropriate for the aerobic bacteria. Wastewater that has been partially or fully decontaminated may be moved to another section of a wastewater pond.

In one aspect, embodiments disclosed herein relate to in-situ aerobic decontamination of emergency discharged wastewater. One or more embodiments relate to a wastewater pond with a divider partitioning the wastewater pond into one or more sections for decontamination of wastewater and one or more sections for storage or evaporation of wastewater.

Turning now to FIG. 1, FIG. 1 illustrates a wastewater pond used for emergency discharged water from an oil and gas processing facility. Emergency discharged wastewater 101 is discharged into a pond. Wastewater 103 stored in the wastewater pond may evaporate 109 while stored. Eventually a third-party wastewater treatment provider 107 removes the remaining wastewater from the wastewater pond.

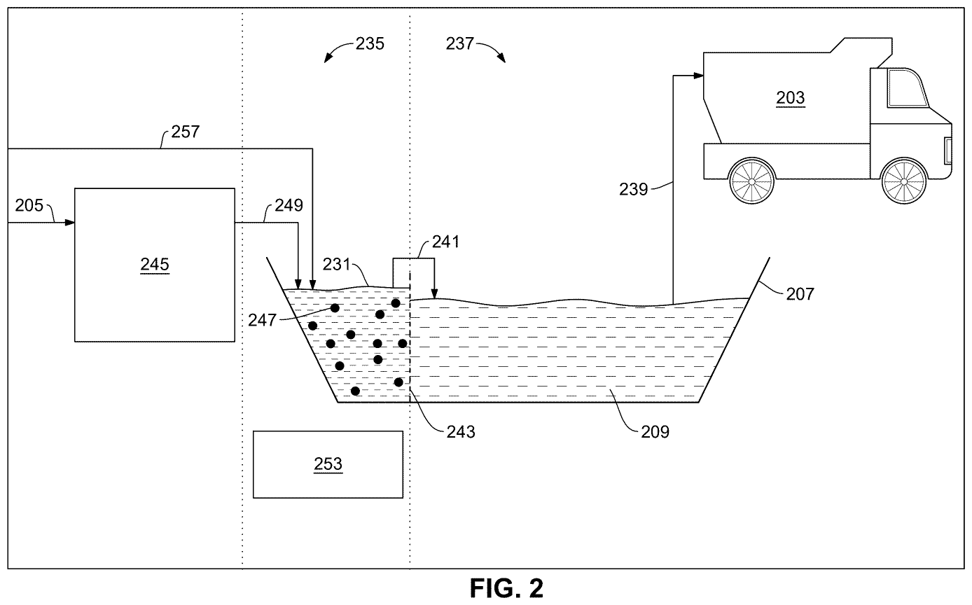

Turning now to FIG. 2, FIG. 2 illustrates a wastewater pond according to one or more embodiments. The untreated wastewater stream 205 and the bypass wastewater stream 257 may come from an oil and gas operation. The discharged wastewater may be discharged due to a process emergency. Process emergencies may comprise process disruptions and unexpected changes in process operation. For example, a process emergency may be caused by the failure of equipment, such as a pump or valve, used as a routine part of handling untreated wastewater or other fluids. Process emergencies further comprise situations where generation of wastewater exceeds a predetermined threshold. Emergency discharged wastewater is wastewater discharged due to a process emergency. Thus, an emergency wastewater pond is a pond configured to receive emergency discharged wastewater.

Either a preconditioned wastewater stream 249 or a bypass wastewater stream 257, or both, may carry emergency discharged wastewater from an oil and gas process. In some embodiments, the untreated wastewater stream 205 is enriched to support aerobic digestion of contaminants by a preconditioning system 245 producing a preconditioned wastewater stream 249.

The wastewater pond is partitioned by a divider 243 into a first section 235 and a second section 237. The first section 235 contains wastewater with in-situ decontamination 231. For example, a biological agent 247 may be disposed within the first section 235 and configured to decontaminate wastewater. The second section 237 contains wastewater with reduced contamination 209. In some embodiments, the wastewater pond may consist of a single pond divided or partitioned by a divider. In other embodiments, a wastewater pond may be a system of two ponds that may be dug and constructed adjacent to one another.

Both the preconditioned wastewater stream 249 and the bypass wastewater stream 257 flow into the first section of the wastewater pond from the emergency discharge point. The divider 243 is configured to retain preconditioned wastewater that may have a high concentration of contaminant in the first section and permit wastewater with a low concentration of contaminant to enter the second section 237.

The biological agent 247 perform aerobic digestion reducing contamination from contaminants comprising soluble organic compounds. In some embodiments, the soluble organic contaminants include ethylene glycol (HO—CH₂CH₂—OH). In other embodiments, the soluble organic contaminants include hydrocarbons.

In one or more embodiments, the biological agent 247 comprises one or more bacterial beds.

In one or more embodiments, a conditioning system 253 is configured to maintain conditions in the first section favorable to decontamination by the biological agent. In one or more embodiments with the conditioning system 253, the conditioning system 253 is configured to distribute oxygen to the wastewater in the first section 235 of the wastewater pond. In one or more embodiments, pH is controlled by addition of acid or base. For example, sulfuric acid (H₂SO₄) can be added to lower the pH. For another example, caustic soda (NaOH) may be added to raise the pH.

Methods for oxygenating wastewater include using an aeration system that bubbles air from beneath the wastewater's surface and fountains that spray water through the air before returning the water to the body of wastewater. In one or more embodiments, a bubbling aeration system is used to oxygenate the wastewater. In other embodiments, a spraying or fountain system is used to oxygenate the wastewater.

In one or more embodiments, the divider 243 is configured to partition the wastewater pond into at least a first section and a second section wherein the divider adjustably controls fluid communication between the first section and the second section.

In one or more embodiments, the divider 243 comprises a fluid conduit 241 fluidly connecting the first section 235 to the second section 237. In one or more embodiments with a fluid conduit 241, the fluid conduit 241 is controllably enabled and disabled.

There are multiple possible modes of moving wastewater through the fluid conduit 241. For example, these modes may include, without limitation, gravity-driven flow, displacement-driven flow, pumping wastewater through the fluid conduit, and combinations thereof. In gravity-driven flow, wastewater transverses the fluid conduit under the influence of gravity. Gravity-driven flow may be used when the wastewater level is higher in the first section than in the second section, including when the second section is empty. Displacement-driven flow can be driven by pumping further fluid into the first section, displacing the wastewater in the first section through the fluid conduit into the second section. Displacement-driven flow may pump in wastewater, clean water, or other fluid. The pumping mode may be employed by configuring a pump to directly drive wastewater through the fluid conduit. These modes of moving wastewater may be used alone or in combination, including in combination with further modes of moving wastewater. Any of the above modes could be used without departing from the scope of the invention.

In one or more embodiments, the divider 243 permits water flow from the first section 235 to the second section 237 once the wastewater with in-situ decontamination 231 has its contamination level reduced to a concentration between 40 ppm and 500 ppm.

In one or more embodiments, one or more contamination sensors are configured to enable the fluid conduit when a met or is satisfied.

Methods for measuring ethylene glycol concentration may include, without limitation, refractometry, the measurement of specific gravity such as with a hydrometer, the use of electrochemical sensors, and gas chromatography (GC). A refractometer can pass light through the wastewater and measure the refraction of the light to estimate the contamination level. In some embodiments, refractometry may be used to estimate the level of contamination in wastewater, while in other embodiments, a hydrometer or other method for comparing specific gravity is used to estimate the level of contamination in wastewater. In further embodiments, an electrochemical sensor is used to estimate the level of contamination in wastewater, and in still other embodiments, gas chromatography is used to estimate the level of contamination in wastewater.

In one or more embodiments, the divider 243 permits water flow from the first section 235 to the second section 237 once the wastewater with in-situ decontamination 231 has been decontaminated between 7 to 28 days. In one or more preferred embodiments, the divider 343 permits water flow from the first section 235 to the second section 237 once the wastewater with in-situ decontamination 231 has been decontaminated between 11 to 17 days.

In one or more embodiments, the wastewater with reduced contamination 209 evaporates while stored in the second section 237. In one or more embodiments, a third-party wastewater treatment provider 203 removes outgoing wastewater 239 from the second section 237. In one or more embodiments, the third-party wastewater treatment provider 203 removes the wastewater with in-situ decontamination 231 from the first section 235.

In one or more embodiments, the divider is comprised of material selected from a group consisting of stainless steel, carbon fiber, and a polymer. In one or more preferred embodiments, the divider is composed of stainless steel that is a super austenitic stainless steel. In one or more preferred embodiments, the divider is composed of super austenitic stainless steel that is Alloy 254 stainless steel.

In one or more embodiments, the wastewater pond is lined with a waterproof liner 207. In one or more embodiments, the waterproof liner 207 is composed of high-density polyethylene (HDPE). In one or more embodiments, the divider 243 reduces contamination risks associated with failure of the waterproof liner 207.

In one or more embodiments, the divider 343 is composed of a material selected from a group of stainless steel, carbon fibers, and polymers. In one or more embodiments in which the divider is composed of stainless steel, the stainless steel is 254 SMO (typo 6Mo stainless steel).

In one or more embodiments, wastewater from the second section 337 evaporates. This evaporation reduces the total amount of both water and contamination in the second section 337.

The bacterial agent must be kept alive and ready for use. During decontamination, digestion of the contaminants helps to sustain the bacteria. Bacteria may be sustained when nutrition from decontamination is inadequate, such as between emergencies. As a non-limiting example, chemical dosing with glucose syrup can provide nutrition to the bacteria. As another example, contaminated wastewater may be drawn from an associated oil and gas process to sustain the bacteria.

When not needed for decontamination, the bacterial agent may be stored in storage reservoir. The storage reservoir may be the first section of the wastewater pond or a separate reservoir. The bacterial agent is supplied with adequate hydration, nutrition, and aeration while in the storage reservoir. Hydration may come from added water, for example, additional wastewater. Aeration system may come from an aeration system that bubbles air from beneath the water's surface and fountains that spray water through the air.

Biological agents may be cooled for storage. Cooling includes, without limitation, storage in a cooler environment, refrigeration, and freezing. For example, shade may be provided to the first section of the wastewater pond to reduce its exposure to solar heating. For another example, bacterial beds may be removed from the first section of the wastewater pond and stored in a refrigerator or freezer.

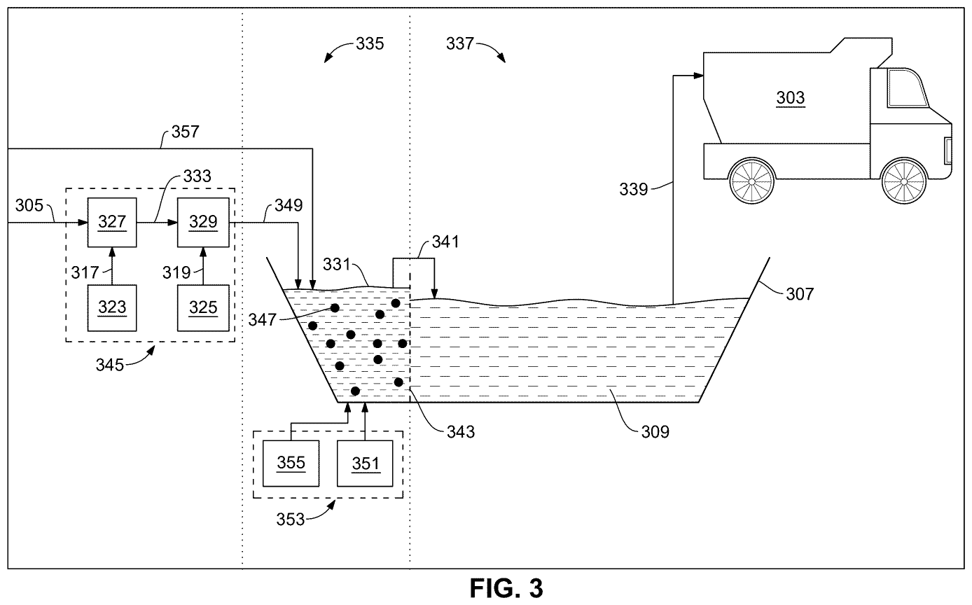

Turning now to FIG. 3, FIG. 3 illustrates a wastewater pond according to one or more embodiments. The untreated wastewater stream 305 and bypass wastewater stream 357 may come from an oil and gas operation. The discharged wastewater may be discharged due to a process emergency. Emergency discharged wastewater is wastewater discharged due to a process emergency. Thus, an emergency wastewater pond is a pond configured to receive emergency discharged wastewater.

Process emergencies include, without limitation, events in which a need for wastewater storage or other management arises without a viable alternative solution readily available. Examples of process emergencies include, but are not limited to, unexpected process disruptions, excess wastewater generation, excess wastewater contamination, unplanned changes in process operation, and process equipment failures. Wastewater may have excessive contamination when its COD (Chemical Oxygen Demand) exceeds 500 mg/L. Excess wastewater generation may occur when wastewater is generated too quickly to be dealt with other than through a process emergency.

The untreated wastewater stream 305 carries emergency discharged wastewater from an oil and gas process. The untreated wastewater stream 305 is enriched to support aerobic digestion of contaminants by a preconditioning system 345.

In one or more embodiments, the preconditioning system 345 comprises a preconditioning nutrient supply 323. In one or more embodiments, the preconditioning system 345 comprises a preconditioning air supply 325.

In one or more embodiments that include the preconditioning nutrient supply 323, the preconditioning nutrient supply 323 provides a preconditioning nutrient enriching stream 317. The untreated wastewater stream 305 is treated with the preconditioning nutrient enriching stream 317 in a preconditioning nutrient mixer 327 producing a partially preconditioned wastewater stream 333. In one or more embodiments that do not include the preconditioning nutrient supply 323, the untreated wastewater stream 305 is directly used as the partially preconditioned wastewater stream 333. In one or more embodiments that do include the preconditioning nutrient supply 323, the preconditioning system is configured to supply a flow of at least one nutrient to the wastewater prior to entry into the first section of the wastewater pond.

In one or more embodiments that include the preconditioning air supply 325, the preconditioning air supply 325 provides a preconditioning air enriching stream 319. The partially preconditioned wastewater stream 333 is treated with the preconditioning air enriching stream 319 in a preconditioning air mixer 329 producing a preconditioned wastewater stream 349. In one or more embodiments that do not include the preconditioning air supply 325, the partially preconditioned wastewater stream 333 is directly used as the preconditioned wastewater stream 349.

The wastewater pond is partitioned by a divider 343 into a first section 335 and a second section 337. The first section 335 contains a wastewater with in-situ decontamination 331. The first section 335 contains bacterial beds 347. The second section 337 contains a wastewater with reduced contamination 309.

The preconditioned wastewater stream 349 flows into the first section of the wastewater pond. The divider 343 is configured to retain wastewater having a high concentration of contaminant in the first section and permit wastewater with a low concentration of contaminant to enter the second section 337.

The bacterial beds 347 perform aerobic digestion reducing contamination from contaminants comprising soluble organic compounds. In one or more embodiments, the soluble organic contaminants comprise ethylene glycol (HO—CH₂CH₂—OH).

In one or more embodiments, the divider 343 permits water flow from the first section 335 to the second section 337 once the wastewater with in-situ decontamination 331 has its contamination level reduced to a concentration between 40 ppm and 500 ppm.

In one or more embodiments, the divider 343 comprises a fluid conduit 341 leading from the first section 335 to the second section 337. The fluid conduit 341 may be controllably enabled and disabled. In one or more embodiments with a fluid conduit 341, one or more pumps are configured to pump wastewater through the fluid conduit 341 when the fluid conduit 341 is in an enabled state. For example, the fluid conduit may be enabled by opening one or more valves and activating one or more pumps (not shown) and the fluid conduit may be disabled by deactivating the one or more pumps and closing the one or more valves.

In one or more embodiments, the divider 343 permits water transfer from the first section 335 to the second section 337 after a predetermined period of time. For example, without limitation, the predetermined period of time may be between 7 and 28 days, or more precisely 11 to 17 days.

In one or more embodiments, the wastewater with reduced contamination 309 evaporates while stored in the second section 337. In one or more embodiments, a third-party wastewater treatment provider 303 removes the outgoing wastewater 339 from the second section 337. In one or more embodiments, the third-party wastewater treatment provider 303 removes the wastewater with in-situ decontamination 331 from the first section 335.

In one or more embodiments, the divider is comprised of material selected from a group consisting of stainless steel, carbon fiber, and a polymer. In one or more preferred embodiments, the divider is composed of stainless steel that is a super austenitic stainless steel. In one or more preferred embodiments, the divider is composed of super austenitic stainless steel that is Alloy 254 stainless steel.

In one or more embodiments, the wastewater pond is lined with a pond liner 307. In one or more embodiments, the pond liner 307 is composed of high-density polyethylene (HDPE). In one or more embodiments, the divider 343 reduces contamination risks associated with failure of the pond liner 307.

In one or more embodiments, nutrients from the preconditioning nutrient supply 323 comprise urea. In one or more embodiments, nutrients from the conditioning nutrient supply 355 comprise urea.

In one or more embodiments, the conditioning air supply 351 distributes oxygen to the wastewater in the first section 335. In one or more embodiments, the conditioning air supply 351 distributes nitrogen to the wastewater in the first section 335.

In one or more embodiments, the preconditioning system 345 enriches the untreated wastewater stream 305 with air before enrichment with nutrients. In one or more embodiments, the preconditioning system 345 enriches the untreated wastewater stream 305 with both air and nutrients simultaneously.

In one or more embodiments, the first section 335 of the wastewater pond is configured to maintain adequate oxygen level, for example in the range of 5 to 8 ppm, pH in the range of 6.5 to 8.5, and sufficient nutrients to maintain aerobic digestion. Oxygen level may also be characterized in terms of saturation limit, for example maintaining oxygen in a range of 75% to 100% saturation.

In one or more embodiments, a conditioning system 353 is used to maintain the conditions of the first section. In one or more embodiments, the conditioning system 353 comprises a conditioning nutrient supply 355. The conditioning nutrient supply 355 is configured to maintain the nutrients for aerobic digestion. In one or more embodiments, the conditioning system 353 comprises a conditioning air supply. The conditioning air supply is configured to maintain the oxygen levels for aerobic digestion. In one or more embodiments, pH is controlled by addition of acid or base. For example, sulfuric acid (H₂SO₄) can be added to lower the pH, and caustic soda (NaOH) may be added to raise the pH.

In one or more embodiments, the divider 343 is composed of a material selected from a group of stainless steel, carbon fibers, and polymers. In one or more embodiments in which the divider is composed of stainless steel, the stainless steel is 254 SMO (typo 6Mo stainless steel).

In one or more embodiments, wastewater from the second section 337 evaporates. This evaporation reduces the total amount of both water and contamination in the second section 337.

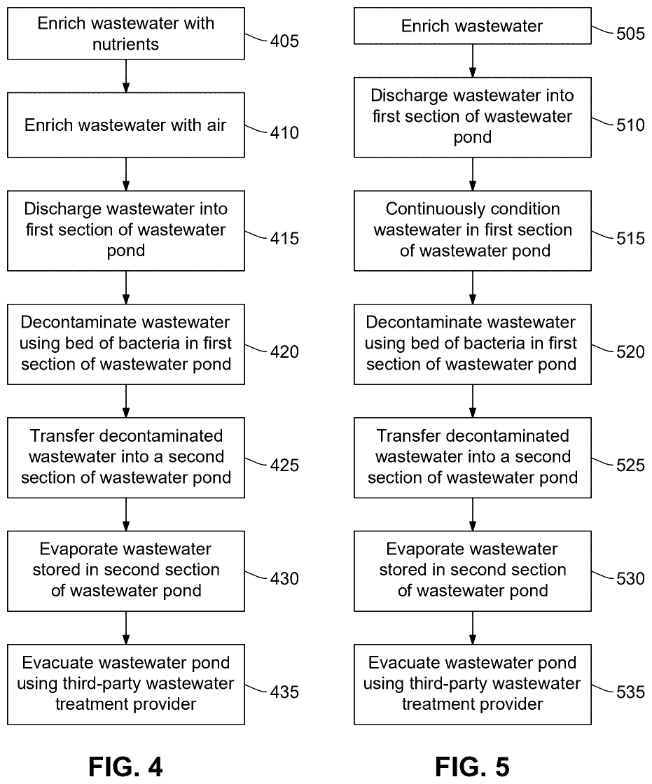

Turning now to FIG. 4, FIG. 4 illustrates a method for storing emergency-discharged wastewater in a wastewater pond according to one or more embodiments disclosed herein. In one or more embodiment, wastewater is enriched with nutrients 405 and then enriched with air 410. Wastewater is then discharged into a first section of the wastewater pond 415. In the first section of the wastewater pond, water is decontaminated using one or more beds of bacteria 420. Decontaminated wastewater is transferred to a second section of the wastewater pond 425. Wastewater and contaminants evaporate in the second section of the wastewater pond 430. Later the wastewater pond is evacuated using a third-party wastewater treatment provider 435.

Turning now to FIG. 5, FIG. 5 illustrates a method for storing emergency-discharged wastewater in a wastewater pond according to one or more embodiments disclosed herein. In one or more embodiment, wastewater is enriched 505. Wastewater is then discharged into a first section of the wastewater pond 510. In the first section of the wastewater pond, wastewater is continuously conditioned 515 to support conditions for aerobic decontamination. In the first section of the wastewater pond, wastewater is decontaminated using one or more beds of bacteria 520. Decontaminated wastewater is transferred to a second section of the wastewater pond 525. Wastewater and contaminants evaporate in the second section of the wastewater pond 530. Later the wastewater pond is evacuated using a third-party wastewater treatment provider 535.

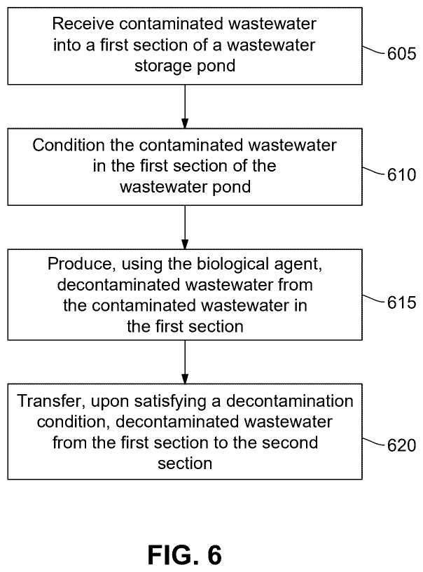

Turning now to FIG. 6, FIG. 6 shows a flowchart illustrating a process for removing contaminants from contaminated wastewater. The process begins with Step 605 where contaminated wastewater into a first section of a wastewater storage pond. The wastewater storage pond may be divided into at least a first section and a second section by a divider disposed between the first section and the second section. The the contaminated wastewater may be emergency discharged wastewater. The divider may include a fluid conduit leading from the first section to the second section, and the fluid conduit is controllably enabled and disabled, for example using one or more valve, and one or more pumps configured to pump wastewater through the fluid conduit when the fluid conduit is in an enabled state. The divider may be fabricated from materials such as stainless steel, such as 254 SMO stainless steel, carbon fiber, or a polymer.

In Step 610, the contaminated wastewater in the first section of the wastewater pond may be conditioned to maintain conditions in the first section of the wastewater pond favorable to decontamination by a biological agent. In some embodiments, the biological agent may be bacteria that may be disposed or contained in in a bacterial bed. The contaminated wastewater may be conditioned with an oxygenation system configured to distribute oxygen to the wastewater within the first section of the wastewater pond. In some embodiments, the contaminated wastewater may be preconditioned prior to entering the first section of the wastewater pond using a preconditioning system configured to supply a flow of at least one nutrient to the contaminated wastewater prior to entry into the first section of the wastewater pond.

In Step 615, decontaminated wastewater may be produced from the first section of the wastewater pond. The biological agent aerobically digests contaminants to reduce contamination of the wastewater. In some embodiments, the contamination level may be characterized by the concentration of ethylene glycol (HO—CH₂CH₂—OH). The biological agent reduces the concentration of ethylene glycol to produce wastewater with reduced decontamination.

In Step 620, decontaminated wastewater is, upon satisfying a decontamination condition, transferred from the first section of the wastewater pond to the second section of the wastewater pond. In some embodiments, decontaminated wastewater is pumped through a fluid conduit fluidly connecting the first section of the wastewater pond to the second section of the wastewater pond. In other embodiments a gate in the divider may be opened to allow the decontaminated wastewater to pass through. The decontamination condition may be determined by the decontamination level. For example, the decontamination condition may be satisfied when the decontamination level falls to a predetermined threshold. For example, the decontamination condition may be met when the concentration of ethylene glycol (HO—CH₂CH₂—OH) falls to or below a predetermined threshold. Threshold concentrations include 5 ppm to 70 ppm, for example 40 ppm may be selected. In other embodiments, the decontamination condition is once the biological agent has decontaminated the wastewater for a predetermined amount of time. For example, the amount of time may be 12 hours to 50 days, for example 14 days may be selected.

Embodiments of the present disclosure may provide at least one of the following advantages. One or more embodiments include decontaminating emergency discharged wastewater in a section of a wastewater pond thereby reducing the amount of soluble organic contaminants in the wastewater before storage and evaporation of the wastewater. One or more embodiments reduce the risk associated with prolonged storage of contaminated wastewater in the pond. One or more embodiments enable in-situ treatment of the wastewater within the wastewater pond by introducing a section designed to contain the biological beds and conditions to enable aerobic digestion of soluble organic contaminants. One or more embodiments provide for reductions to the carbon footprint of these operations.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for removing contaminants from wastewater, the system comprising:
a wastewater pond comprising:
a waterproof liner, configured to retain wastewater in the wastewater pond,
a divider configured to partition the wastewater pond into at least a first section and a second section, wherein the divider adjustably controls fluid communication between the first section and the second section, and
a biological agent disposed within the first section configured to decontaminate wastewater; and
a conditioning system configured to maintain conditions in the first section favorable to decontamination by the biological agent.

2. The system of claim 1, wherein the conditioning system comprises a preconditioning system configured to supply a flow of at least one nutrient to the wastewater prior to entry into the first section of the wastewater pond.

3. The system of claim 1, wherein the biological agent comprises at least one bacterial bed.

4. The system of claim 1, wherein the conditioning system comprises an oxygenation system configured to distribute oxygen to the wastewater within the first section of the wastewater pond.

5. The system of claim 1, wherein the divider comprises:
a fluid conduit leading from the first section to the second section, wherein the fluid conduit is controllably enabled and disabled; and
a gate configured to open allowing wastewater through the fluid conduit when the fluid conduit is in an enabled state.

6. The system of claim 5, further comprising at least one contamination sensor configured to enable the fluid conduit when a decontamination condition has been met.

7. The system of claim 1, wherein the waterproof liner comprises a high-density polyethylene (HDPE) liner.

8. The system of claim 1, wherein the divider comprises a material selected from a group consisting of stainless steel, carbon fiber, and a polymer.

9. The system of claim 1, wherein the first section of the wastewater pond further comprises:
a shading body that blocks light from heating the first section of the wastewater pond when not in use for decontamination. and
a system for ensuring adequate water levels in the first section of the wastewater pond to prevent drying out the biological agent;
wherein the conditioning system is further configured to maintain conditions favorable to storage of the biological agent for storage when not in use for decontamination.

10. The system of claim 1, wherein contaminated wastewater comprises ethylene glycol (HO—CH₂CH₂—OH).

11. The system of claim 1, wherein the conditioning system enriches wastewater with nutrients comprising urea.

12. The system of claim 1, wherein the system is configured to receive emergency discharged wastewater.

13. A process for removing contaminants from contaminated wastewater, the process comprising:
receiving contaminated wastewater into a first section of a wastewater storage pond, wherein the wastewater storage pond is divided into at least a first section and a second section by a divider disposed between the first section and the second section;
conditioning the contaminated wastewater in the first section of the wastewater pond to maintain conditions in the first section of the wastewater pond favorable to decontamination by a biological agent;
producing, using the biological agent, decontaminated wastewater from the contaminated wastewater in the first section; and
transferring, upon satisfying a decontamination condition, decontaminated wastewater from the first section to the second section.

14. The process of claim 13, wherein conditioning the contaminated wastewater in the first section comprising preconditioning the contaminated wastewater using a preconditioning system configured to supply a flow of at least one nutrient to the contaminated wastewater prior to entry into the first section of the wastewater pond.

15. The process of claim 13, wherein the biological agent comprises bacteria disposed in a bacterial bed.

16. The process of claim 13, wherein the contaminated wastewater is conditioned with an oxygenation system configured to distribute oxygen to the wastewater within the first section of the wastewater pond.

17. The process of claim 13, wherein transferring decontaminated wastewater from the first section to the second section comprises opening a gate to allow the decontaminated wastewater through a fluid conduit fluidly connecting the first section to the second section.

18. The process of claim 17, further using a contamination sensor to control enablement of the fluid conduit when a decontamination condition has been met.

19. The process of claim 13, wherein the contaminated wastewater comprises ethylene glycol (HO—CH₂CH₂—OH).

20. The process of claim 13, wherein the contaminated wastewater is emergency discharged wastewater.
